(19) United States
(12) Patent Application Publication
(10) Pub. No.: US 2006/0165580 A1
(43) Pub. Date: Jul. 27, 2006

(54) Heterogeneous copper catalysts

(75) Inventor: Bruce H. Lipshutz, Goleta, CA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: THE REGENTS OF THE UNIVERSITY OF CALIFORNIA, Oakland, CA (US)

(21) Appl. No.: 11/341,044

(22) Filed: Jan. 26, 2006

Related U.S. Application Data
(60) Provisional application No. 60/647,483, filed on Jan. 26, 2005.

(51) Int. Cl. C01B 25/26

(52) U.S. Cl. 423/314

(57) ABSTRACT

The present invention provides a class of heterogeneous copper catalysts that catalyze the addition of various species across an unsaturated system (e.g., C—C and C-heteroatom systems), the additions occurring in a 1,2- or 1,4-manner. Also provided are methods of using the catalysts to perform the additions and methods of making the catalysts themselves.

### CROSS-REFERENCE TO RELATED APPLICATIONS

This is a non-provisional filing of U.S. Provisional Patent Application No. 60/647,483, filed on Jan. 26, 2005, the disclosure of which is incorporated herein by reference in its entirety for all purposes.

### FIELD OF THE INVENTION

The present invention resides in the field of catalysis, specifically heterogeneous catalysis.

### BACKGROUND OF THE INVENTION

The development of effective asymmetric reactions that enable the enantioselective formation of one chiral center over another continues to be an important area of research. One such asymmetric reaction involves the introduction of a chiral center into a molecule through the enantioselective hydrogenation of a prochiral unsaturated bond by using a transition metal catalyst bearing chiral organic ligands. Numerous chiral phosphine catalysts have been developed to enantioselectively introduce chiral centers to prochiral olefins, carbonyls and imines with high enantiomeric excess. One such class of chiral catalysts employs the chiral phosphine ligand 2,2′-bis(diphenylphosphino)-1,1′-binaphthyl (hereinafter referred to as “BINAP”).

A second important area of research relates to the development of water-soluble organometallic catalysts. Conventionally, catalytically active organometallic complexes have been applied as homogeneous catalysts in solution in the organic reaction phase. Difficulties associated with recovery of the homogeneous catalysts from the reactants and products diminish the utility of these homogeneous catalysts, especially when the cost of the catalyst is high or where there is the need to isolate the reaction products in high purity.

One mode in which water soluble organometallic catalysts have been used is in two-phase systems comprising an aqueous phase and a water immiscible phase (e.g. ethyl acetate-water). Separation of the organometallic catalyst from organic reactants and products is greatly simplified due to the insolubility of the catalyst in the water immiscible phase. However, in some instances, the utility of the two-phase system has been limited by a lack of substrate and/or reactant solubility in the aqueous phase, by the limited interfacial area between the two phases, and by poor selectivity.

Supported phase (SP) organometallic catalysts have been developed to overcome some of the shortcomings associated with two-phase reaction systems. In a supported phase system the interfacial area between the support phase, which contains the organometallic catalyst, and the water immiscible (bulk organic) phase, is greatly enhanced.

It has been estimated that 70-80% of all metal-based catalysis performed in industry is done heterogeneously. The benefits ascribed to this mode of reaction are numerous, including (1) simplicity in workup; filtration suffices to remove the catalyst; (2) recyclibility; catalysts may retain activity throughout several reaction cycles leading to high throughput at reduced expense; (3) minimized waste disposal; catalysts that retain impregnated metals reduce environmental concerns. Of the many solid supports that have been used over the past several decades (e.g.; SiO₂, Al₂O₃, Kieselgohr, molecular series, etc.), charcoal is among the most common. It's large surface area and minimal cost are attractive features. Moreover, its intricate albeit ill-defined pore structure allows for the straightforward mounting of transition metals in the form of their salts, usually by simple evaporation of their aqueous solutions in the presence of activated charcoal. Thermal treatment of such metal-impregnated charcoal can be used to further reorganize the initial disposition of metal atoms, which can have a major impact on their accessibility and hence, catalytic activity.

One metal that has been extensively utilized in heterogeneous catalysts following impregnation on charcoal is copper. The species copper-on-charcoal (“Cu/C”), akin to related catalysts “Ni/C”, “Co/C”, etc., exists mainly in its oxidized [copper (II)] state, and thus as CuO, although copper(I) oxide (Cu₂O) is also present within the pores. The nature of each catalyst “Cu/C”, however, varies significantly as a function of its preparation and handling. Thus, catalysts prepared from CuCl₂, Cu(OAc)₂, or Cu(NO₃)₂ are likely to be discrete entities, displaying highly variable chemical properties as well as distinct physical properties, as manifested using sophisticated analytical techniques such as SEM (scanning electron microscopy) and X-ray diffraction.

The chemistry of Cu/C can be broadly classified as relating to hydrogenations or dehydrogenations, with essentially no uses reported in the literature relating to synthetic organic chemistry. Given the importance that organocopper reagents, of both catalytic and stoichiometric types, play as a means of constructing carbon-carbon, carbon-heteroatom, and carbon-hydrogen bonds under homogeneous conditions, there would seem to be many opportunities for utilizing heterogeneous Cu/C chemistry. Not surprisingly, therefore, no precedent exists for use of Cu/C in the field of asymmetric catalysis, where copper is associated with one or more nonracemic ligands and is thus capable of inducing chirality in a prochiral substrate.

One area where Cu/C could find immediate application involves its in situ conversion to copper hydride-on-charcoal (“CuH/C”), in particular when ligated by nonracemic amines, phosphines, or carbenes, (“L*”). Asymmetric reductions of several functional groups, such as aromatic ketones and imines, α,β-unsaturated ketones and esters, and unsaturated lactones and lactams, lead to valued intermediates upon exposure to (L*)CuH in solution. The corresponding process under heterogeneous conditions of any sort is unknown.

The advantages of supported phase organometallic catalyst systems have prompted further investigation into copper-based catalyst systems that retain the beneficial characteristics of homogeneous catalyst systems while increasing ease of use, yield and enantioselectivity.

### SUMMARY OF THE INVENTION

The present invention provides a heterogeneous copper catalyst that is immobilized on a substrate, such as carbon. The catalyst of the invention is of use to effect various transformations of selected substrates. In general, the invention provides access to a catalyst that is effective at transforming chiral or prochiral substrates into chiral products. Exemplary catalysts of the invention perform transformations that proceed with a high degree of enantioselectivity, providing an excess of one enantiomeric product over its antipode.

Many heterogeneous catalytic processes are used in the commercial production of polymers, solvents, plasticizers and other commodity chemicals. Consequently, due to the extremely large worldwide chemical commodity market, even small incremental advances in yield or selectivity in any of these commercially important reactions are highly desirable. Furthermore, the discovery of certain catalysts that may be useful for applications across a range of these commercially important reactions is also highly desirable not only for the commercial benefit, but also to enable consolidation and focusing of research and development efforts to a particular group of compounds.

One area where Cu/C finds immediate application involves its in situ conversion to copper hydride-on-charcoal (“CuH/C”), in particular when ligated by nonracemic amines, phosphines, or carbenes, (“L”). Asymmetric reductions of several functional groups, such as aromatic ketones and imines, α,β-unsaturated ketones and esters, and unsaturated lactones and lactams, lead to valued intermediates upon exposure to (L)ₘCuH in solution. The corresponding process under heterogeneous conditions of any sort is unknown.

Thus, in an exemplary embodiment, the invention provides in an exemplary embodiment, the invention provides a catalytic composition that includes a copper complex absorbed onto a substrate. An exemplary copper complex has a formula that is selected from Formulae I and II:
Lₘ—Cu(Z) (I)
Lₘ—Cu(I)—H (II).
In each of Formulae I and II, the symbol L represents a ligand that complexes the copper. The index m is a number greater than 0, e.g., at least 0.01. When m is greater than 1 each L is independently selected. The symbol Z represents s an oxidation state of the copper, and it is an integer selected from 0, 1 and 2. A generally preferred substrate is carbon. The carbon can be in any convenient state or form, and the selection of an appropriate substrate for the catalyst of the invention is within the knowledge and abilities of those of skill in the art.

Also provided are catalytic processes for performing reactions that utilize the compositions of the method, as well as methods for preparing the compositions of the invention.

Additional embodiments, objects and advantages of the invention are apparent from the detailed description that follows.

### BRIEF DESCRIPTION OF THE DRAWINGS

FIG. 1 is a scheme for preparing copper immobilized on carbon (“Cu/C”).

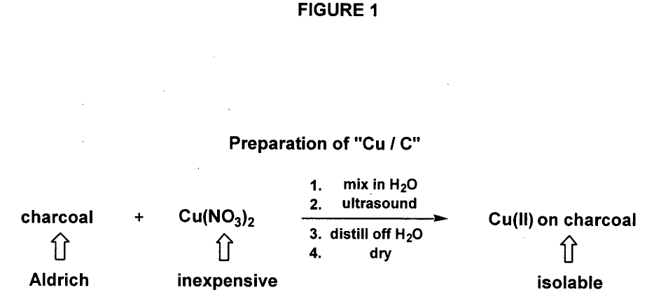

FIG. 2 is a scheme for activating the copper immobilized on carbon by contacting it with a silane, after which the catalyst is used to reduce an unsaturated ketone.

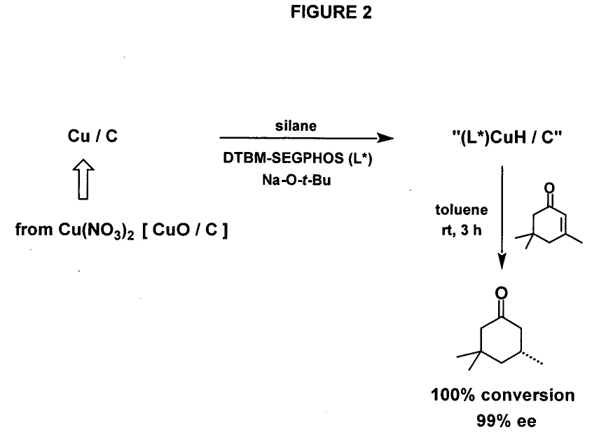

FIG. 3 is a scheme for activating the copper immobilized on carbon by contacting it with a silane, after which the catalyst is used to reduce an aromatic ketone.

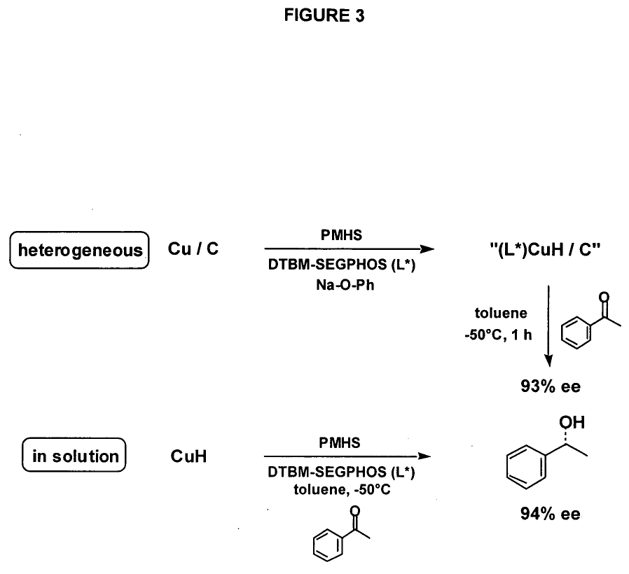

### DETAILED DESCRIPTION OF THE INVENTION AND THE PREFERRED EMBODIMENTS

Definitions

The term “alkyl,” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below, such as “heteroalkyl.” Alkyl groups, which are limited to hydrocarbon groups are termed “homoalkyl”.

The term “alkylene” by itself or as part of another substituent means a divalent radical derived from an alkane, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The terms “alkoxy,” “alkylamino” and “alkylthio” (or thioalkoxy) are used in their conventional sense, and refer to those alkyl groups attached to the remainder of the molecule via an oxygen atom, an amino group, or a sulfur atom, respectively.

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂,—S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′-represents both —C(O)₂R′—and —R′C(O)₂—.

As used herein, “acyl” refers to a moiety that includes the —C(O)— group bound to an “acyl substituent.” In general, an “acyl substituent” includes an alkyl, heteroalkyl, aryl, heteroaryl or heterocycloalkyl group. As used herein, the term “acyl substituent” refers to groups attached to, and fulfilling the valence of a carbonyl carbon that is a component of substrates for and compounds made by the methods of the present invention.

The terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like.

The terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

The term “aryl” means, unless otherwise stated, a polyunsaturated, aromatic, hydrocarbon substituent which can be a single ring or multiple rings (preferably from 1 to 3 rings) which are fused together or linked covalently. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quatemized. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

For brevity, the term “aryl” when used in combination with other terms (e.g., aryloxy, arylthioxy, arylalkyl) includes both aryl and heteroaryl rings as defined above. Thus, the term “arylalkyl” is meant to include those radicals in which an aryl group is attached to an alkyl group (e.g., benzyl, phenethyl, pyridylmethyl and the like) including those alkyl groups in which a carbon atom (e.g., a methylene group) has been replaced by, for example, an oxygen atom (e.g., phenoxymethyl, 2-pyridyloxymethyl, 3-(1-naphthyloxy)propyl, and the like).

Each of the above terms (e.g., “alkyl,” “heteroalkyl,” “aryl” and “heteroaryl”) include both substituted and unsubstituted forms of the indicated radical. Preferred substituents for each type of radical are provided below.

Substituents for the alkyl, and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) are generally referred to as “alkyl substituents” and “heteroakyl substituents,” respectively, and they can be one or more of a variety of groups selected from, but not limited to: —OR′, =O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Similar to the substituents described for the alkyl radical, the aryl substituents and heteroaryl substituents are generally referred to as “aryl substituents” and “heteroaryl substituents,” respectively and are varied and selected from, for example: halogen, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″)═NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, (C₁-C₈)alkyl and heteroalkyl, unsubstituted aryl and heteroaryl, (unsubstituted aryl)-(C₁-C₄)alkyl, and (unsubstituted aryl)oxy-(C₁-C₄)alkyl. When a compound of the invention includes more than one R group, for example, each of the R groups is independently selected as are each R′, R″, R′″ and R″″ groups when more than one of these groups is present.

Two of the aryl substituents on adjacent atoms of the aryl or heteroaryl ring may optionally be replaced with a substituent of the formula -T-C(O)—(CRR′)_{q}—U—, wherein T and U are independently —NR—, —O—, —CRR′— or a single bond, and q is an integer of from 0 to 3. Alternatively, two of the substituents on adjacent atoms of the aryl or heteroaryl ring may optionally be replaced with a substituent of the formula -A-(CH₂)ᵣ—B—, wherein A and B are independently —CRR′—, —O—, —NR—, —S—, —S(O)—, —S(O)₂—, —S(O)₂NR′— or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X—(CR″R′″)_{d}—, where s and d are independently integers of from 0 to 3, and X is —O—, —NR′—, —S—, —S(O)—, —S(O)₂—, or —S(O)₂NR′—. The substituents R, R′, R″ and R′″ are preferably independently selected from hydrogen or substituted or unsubstituted (C₁-C₆)alkyl.

As used herein, the term “heteroatom” includes oxygen (O), nitrogen (N), sulfur (S) and silicon (Si).

Introduction

The present invention resides in the field of heterogeneous catalysis. A distinction is made within the field of catalysis between homogeneous and heterogeneous catalyst systems. Homogeneous catalysts are considered to be catalyst systems in which the catalyst and reactants are in the same phase. That is, the catalyst component is distributed on a molecular or submicroscopic level (e.g., dissolved), usually in a liquid phase such as a solution (which may also be eutectic or a solid solution). In heterogeneous catalyst systems, the catalyst and reactants are in different phases, and are usually considered as more particulate in nature (rather than atomic or individually molecular), with the particles generally too large to be considered molecular in nature. There is, of course, a gradation between heterogeneous and homogeneous systems where the molecules become more particle-like and solutions become dispersions or suspensions, but the distinctions are still generally maintained in the art with intermediate systems referred to as transitional systems between homogeneous and heterogeneous.

Although homogeneous catalyst systems can provide a high initial activity and selectivity, homogeneous or soluble catalysts are difficult to separate from the final product. Extreme measures are therefore required to recover even a small portion of the valuable catalyst after the reaction is complete. When the catalysts include metals, there is the added concern of the environmental impact of these significant metal losses.

Heterogeneous catalyst systems are known to be more efficient than homogeneous catalyst systems because the catalyst can be easily separated from the pure product, since each is in a different phase. Also, clean up of the system and recycle of the catalyst are both much easier, and heterogeneous systems lend themselves easily to continuous processes, which can be very economical.

The invention further includes the use of such supported phase catalysts for asymmetric synthesis of optically active compounds containing chiral carbon-carbon and carbon-hetero atom bonds (e.g., amination, etherification), or the asymmetric reduction of ketones, imines, or beta-keto esters, such as ethyl butyrylacetate. Generally, such asymmetric reactions include those reactions in which organometallic catalysts are commonly used, such as reduction and isomerization reactions on unsaturated substrates and carbon-carbon bond forming reactions, and specifically reduction, hydroboration, hydrosilylation, hydride reduction, hydroformylation, alkylation, allylic alkylation, arylation, alkenylation, epoxidation, hydrocyanation, disilylation, cyclization and isomerization reactions.

Thus, in an exemplary embodiment, the invention provides a composition that includes a copper complex absorbed onto a substrate. An exemplary copper complex has a formula that is selected from Formulae I and II:
Lₘ—Cu(Z) (I)
Lₘ—Cu(I)—H (II).
In each of Formulae I and II, the symbol L represents a ligand that complexes the copper. The index m is the integer 1, 2 or 3. When m is greater than 1 each L is independently selected. The symbol Z represents s an oxidation state of the copper, and it is an integer selected from 0, 1 and 2. A generally preferred substrate is carbon. The carbon can be in any convenient state or form, and the selection of an appropriate substrate for the catalyst of the invention is within the knowledge and abilities of those of skill in the art.

The stoichiometric source of hydride in reactions of catalytic (L)ₘCuH is, conveniently, a silane such as polymethyhydrosiloxane (PMHS) or tetramethydisiloxane (TMDS). Reductions utilizing these species are referred to as asymmetric hydrosilylations.

Ligands that function in the intended capacity are far too numerous to cite. Those that have already been shown to associate with CuH and effect asymmetric reductions include: BIPHEP (Roche), BINAP and SEGPHOS (Takasago), JOSIPHOS (Solvias), and non-proprietary NH carbene ligands described in the recent literature. See, for example, Tang, W. and Zhang X. Chem. Rev. 103: 3029 (2003) and Ojima, I., Ed. Catalytic Asymmetric Synthesis; Wiley-VCH: New York, 2000.

The composition of the invention is exemplified herein by reference to species in which the ligand is a phosphorus-containing ligand, e.g., phosphine, or phosphinyl ligand. Those of skill in the art will recognize that this focus is for clarity of illustration and other ligands have utility as well, for example, sulfinyl and sulfonyl ligands are of use in the compounds of the invention.

Phosphorus-containing ligands are ubiquitous in catalysis and are used for a number of commercially important chemical transformations. Phosphorus-containing ligands commonly encountered in catalysis include phosphines and phosphates. Monophosphine and monophosphite ligands are compounds that contain a single phosphorus atom that serves as a donor to a metal. Bisphosphine, bisphosphite, and bis(phosphorus) ligands in general, contain two phosphorus donor atoms and normally form cyclic chelate structures with transition metals.

There are several industrially important catalytic processes employing phosphorus ligands. For example, U.S. Pat. No. 5,910,600 to Urata, et al. discloses that bisphosphite compounds can be used as a constituting element of a homogeneous metal catalyst for various reactions such as hydrogenation, hydroformylation, hydrocyanation, hydrocarboxylation, hydroamidation, hydroesterification and aldol condensation.

U.S. Pat. No. 5,512,696 to Kreutzer, et al. discloses a hydrocyanation process using a multidentate phosphite ligand, and the patents and publications referenced therein describe hydrocyanation catalyst systems pertaining to the hydrocyanation of thylenically unsaturated compounds. U.S. Pat. Nos. 5,723,641, 5,663,369, 5,688,986 and 5,847,191 disclose processes using zero-valent nickel and multidentate phosphite ligands.

U.S. Pat. No. 5,821,378 to Foo, et al. discloses reactions that are carried out in the presence of zero-valent nickel and a multidentate phosphite ligand. PCT Application WO99/06357 discloses multidentate phosphite ligands having alkyl ether substituents on the carbon attached to the ortho position of the terminal phenol group.

Exemplary phosphorus-containing ligands of use in the present invention include (R)-(−)-1-[(S)-2-diphenylphosphino)ferrocenyl]ethyldi-tert-butylphosphine; [(4R)-[4,4′-bi-1,3- benzodioxole]-5,5′-diyl]bis[bis[3,5-bis(1,1-dimethylethyl)-4-methoxyphenyl]-phosphine; and (R)-(−)-1-(6,6-dimethoxybiphenyl-2,2′-diyl)bis(3,5-dimethylphenyl)phosphine); and combinations thereof. Specific examples of the chiral ligand include cyclohexylanisylmethylphosphine (CAMP), 1,2-bis(anisylphenylphosphino)ethane (DIPAMP), 1,2-bis(alkylmethylphosphino)ethane (BisP*), 2,3-bis(diphenylphosphino)butane (CHIRAPHOS), 1,2-bis(diphenylphosphino)propane (PROPHOS), 2,3-bis(diphenylphosphino)-5-norbomene (NORPHOS), 2,3-O-isopropylidene-2,3-dihydroxy-1,4-bis(diphenylphosphino)butane (DIOP), 1-cyclohexyl-1,2-bis(diphenylphosphino)ethane (CYCPHOS), 1-substituted-3,4-bis(diphenylphosphino)pyrrolidine (DEGPHOS), 2,4-bis(diphenylphosphino)pentane (SKEWPHOS), 1,2-bis(substituted phospholano)benzene (DuPHOS), 1,2-bis(substituted phospholano)ethane(BPE), 1-(substituted phospholano)-2-(diphenylphosphino)benzene (UCAP-Ph), 1-[bis(3,5-dimethylphenyl)phosphino]-2-(substituted phospholano)benzene (UCAP-DM), 1-(substituted phospholano)-2-[bis(3,5-di(t-butyl)-4-methoxyphenyl)phosphino]benzene (UCAP-DTBM), 1-(substituted phospholano)-2-(di-naphthalen-1-yl-phosphino)benzene (UCAP-(1-Nap)), 1-[1′, 2-bis(diphenylphosphino)ferrocenyl]ethylamine (BPPFA), 1-[1′,2-bis(diphenylphosphino)ferrocenyl]ethyl alcohol (BPPFOH), 2,2′-bis(diphenylphosphino)-1,1′-dicyclopentane (BICP), 2,2′- bis(diphenylphosphino)-1,1′-binaphthyl (BINAP), 2,2′-bis(diphenylphosphino)-1,1′-(5,5′,6,6′,7,7′,8,8′-octahydrobinaphthyl)(H₈-BINAP), 2,2′-bis(di-p-tolylphosphino)-1,1′-binaphthyl (TOL-BINAP), 2,2′- bis[di(3,5-dimethylphenyl)phosphino]-1,1′-binaphthyl (DM-BINAP), 2,2′- bis(diphenylphosphino)-6,6′-dimethyl-1-1′-biphenyl (BICHEP), [4,4′-bi-1,3-benzodioxole]-5,5′-diylbis[diphenylphosphine] (SEGPHOS), [4,4′-bi-1,3-benzodioxole]-5,5′-diylbis[bis(3,5,-dimethylphenyl)phosphine] (DM-SEGPHOS), [(4S)-[4,4′-bi-1,3-benzodioxole]-5,5′-diyl]bis[bis[3,5,-bis(1,1-dimethylethyl)-4-methoxyphenyl]phosphine] (DTBM-SEGPHOS), etc.

Other exemplary ligands of use in the present invention include NH carbenes. See, for example, Perry et al., Tetrahedron: Asymmetry 14: 951 (2003).

The ligand can be chiral or non-chiral, but is preferably a chiral, non-racemic ligand.

The invention also provides methods of preparing the compositions of the invention. In an exemplary method, a species according to Formula I is prepared by first forming a mixture of a copper species, e.g., a salt, and a substrate, such as carbon, e.g., activated carbon, in aqueous medium. The mixture is then sonicated. The aqueous solvent is preferably removed, thereby immobilizing the copper species onto the carbon (“Cu/C”). The immobilized copper is complexed with one or more ligand by contacting the immobilized copper species with a ligand under conditions appropriate to effect the desired complexation. In an exemplary embodiment, the ligand is a chiral, non-racemic ligand.

In another exemplary embodiment, a method similar to that set forth above is used to prepare a composition according to Formula II. This method includes an additional step, contacting the immobilized, complexed copper species with a hydrogen source, e.g., a silane or a stannane, thereby forming the desired immobilized copper complex.

Although there are several art-recognized preparations of Cu/C including the use of Cu(NO₃)₂ as precursor, none use the benefits of ultrasound as a means of enhancing the level of absorption of Cu(II) onto the solid support. The ultrasound technique provides a surprisingly high degree of copper immobilization. Analysis of the extent of ‘bleed’ of copper following impregnation using the quantitative technique, inductively coupled plasma atomic emission spectroscopy (ICP AES), showed that extremely low levels of copper ions, in the ppb range, could be detected.

The compositions of the invention can be formed in situ or they can be preformed, packaged and stored until needed.

By selection of the substrate, concentration of copper species, and power and duration of sonication, compositions having a wide range of immobilized copper contents are readily accessible according to the methods of the invention. In an exemplary embodiment, the invention provides immobilized copper species according to Formulae I and II in which the composition include from about 0.1 to about 15% copper by weight.

With Cu/C made by the ultrasound method above, unprecedented heterogeneous asymmetric hydrosilylations were achieved upon addition of excess PMHS, catalytic amounts of SEGPHOS, and the unsaturated cyclic ketone, isophorone.

In another embodiment, the invention provides methods of using the novel compositions to effect transformations of substrate species. An exemplary transformation is an addition across unsaturation in a substrate in either a 1,2- or 1,4-manner. The method includes contacting an unsaturated substrate with a compound according to Formulae I or II under conditions appropriate to effect the addition across the bond. In a preferred embodiment, the addition is an asymmetric addition, e.g., a hydrosialylation. In one embodiment, the addition is effected by contacting the substrate with a composition according to Formula I and a silane. In another exemplary embodiment, the substrate is contacted with a species according to Formula II.

In yet another embodiment, the copper species according to Formulae I or II is contacted with a salt of an acidic compound, e.g., an organic acid, an inorganic acid, an organic alcohol and combinations thereof. In an exemplary process according to the invention, the copper species is contacted with the salt prior to introducing the substrate into the reaction mixture. The positive counter-ion is preferably a mono-valent ion, e.g., Na⁺, K⁺, however, the choice of counterion for a selected purpose or property, e.g., reactivity, solubility, etc., is well within the abilities of those of skill in the art.

According to the procedures set forth above, the catalysts of the invention can be utilized to effect the transformation: 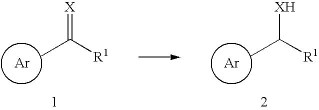
in which 2 produced in the reaction is an optically active compound that is a member selected from: 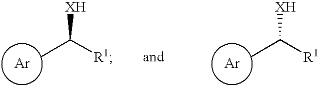
in which Ar is a substituted or unsubstituted aryl (e.g., substituted or unsubstituted phenyl), or a substituted or unsubstituted heteroaryl moiety. The symbol R¹ represents substituted or unsubstituted alkyl, substituted or unsubstituted acyl, substituted or unsubstituted heteroalkyl, substituted or unsubstituted aryl, substituted or unsubstituted heteroaryl or substituted or unsubstituted heterocycloalkyl moieties. X is O or NR², in which R² is H, acyl, substituted or unsubstituted alkyl, substituted or unsubstituted heteroalkyl, substituted or unsubstituted aryl, substituted or unsubstituted heteroaryl and substituted or unsubstituted heterocycloalkyl.

In another exemplary embodiment, the invention provides a method as set forth above of performing the reaction: 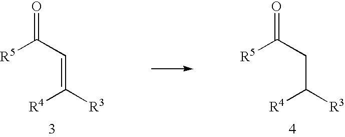
in which 4 produced in the reaction is an enantiomer that is a member selected from: 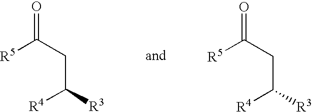
in which R³, R⁴, and R⁵ are independently selected from H, substituted or unsubstituted alkyl, substituted or unsubstituted aryl, substituted or unsubstituted heteroaryl and substituted or unsubstituted heterocycloalkyl. R⁴ and R⁵, together with the carbon atoms to which they are bound are optionallyjoined to form a substituted or unsubstituted 5-15-member cycloalkyl or substituted or unsubstituted 5-15-member heterocycloalkyl moiety.

In a preferred embodiment, a catalytic quantity of a sodium salt of an alkyl alcohol (e.g., t-butanol) or an aryl alcohol (e.g., phenol). Under these novel conditions (L)ₘCU/C bearing copper in the +2 oxidation state is readily reduced by the silane to (L)ₘCu(I)H/C, after which the intended reduction takes place smoothly at ambient temperatures. Reduction of isophorone using Na-O-t-Bu as additive, PMHS, and the di-tert-butyl-methoxydiphenylphosphinyl analog of the parent SEGPHOS ligand system (i.e., R-(−)-DTBM-SEGPHOS) in toluene proceeded in three hours to afford the desired product in >98% ee and in high yield. Use of NaO-Ph in place of NaO-t-Bu further accelerated the hydrosilylation, leading to complete conversion within one hour.

Asymmetric reduction of an aryl ketone using Cu/C is also readily achieved. Acetophenone is easily reduced with (DTBM-SEGPHOS)CuH in toluene at −50° C. with an observed 94% ee. Cu/C can also be employed, in its (DTBM-SEGPHOS)CuH/C state, to carry out the same reaction even at the same cold temperature. Thus, using catalytic CuH/C, acetophenone was converted to its derived product alcohol (after hydrolysis of the initially formed silyl ether) at −50° C. in 93% ee.

Thus, the present invention provides a method of producing compounds in which the optical purity of the optically active compounds is generally at least about 90% ee, preferably at least about 95% ee, and more preferably at least about 99% ee.

It has also been found that the catalysts of the invention operate efficiently under sonication. Thus, in yet a further exemplary embodiment, the catalytic reactions using the species of the invention are run under sonication.

The following examples are provided to illustrate the conjugates, and methods and of the present invention, but not to limit the claimed invention.

### EXAMPLES

### Example 1

### Preparation of the Catalyst

A 100 mL rb flask equipped with stir bar was flame dried and purged with argon. Darco® KB activated carbon (5.00 g, 100 mesh, 25% water by content) was added to the flask and the sides rinsed with DI H₂O (30 mL). Cu(NO₃)₂.3H₂O (Cu content by ICP anaylsis: 33.4% by mass, 0.5557 g, 2.92 mmol) was added to a 25 mL Erlenmeyer flask and dissolved in H₂O (5 mL). The Cu(NO₃)₂ was added via pipette to the charcoal slurry followed by rinsing of the Erlenmeyer flask with H₂O (2 mL) 3 times. H₂O (34 mL) was used to rinse the sides of the rb flask. The flask was stirred rapidly for 1 min while being purged under argon. The flask was placed in a sonication bath for 30 min, followed by distillation of the H₂O using an argon purged distillation setup and a preheated 160 ° C. sand bath. Once the distillation was complete, the temperature was raised to 200° C. The flask was then removed from the sand bath and allowed to cool to rt. Toluene (50 mL) was added to the rb flask and distilled at 160° C. The bath was raised to 200° C. and then removed from the sand bath. The toluene distillation process was repeated twice. The bath was increased to 210° C. and was held for 10 min, after which the flask was removed and allowed to cool to rt. The black solid was washed with toluene (3×30 mL) under argon into an oven dried 150 mL coarse frit funnel under vacuum. The toluene (90 mL) used to wash the Cu/C was rotary evaporated and analyzed for any remaining copper. The fritted funnel was inverted under vacuum, which allowed the Cu/C to fall off the frit into the collection flask overnight. The collection flask is then dried in vacuo at 110° C. for 18 h. Using these specific amounts, 99.99% of the copper is mounted on the support, giving a 0.7365 mmol Cu(II)/g catalyst or 4.7% Cu/catalyst by weight.

### Example 2

### Asymmetric Reduction of Acetophenone and isophorone Catalyst Pre-Formation

To a 10 mL round bottom flask, equipped with stir bar, oven-dried and purged with argon, was added Cu/C (0.0672 g, 0.05 mmol), (R)-(−) DTBM-SEGPHOS (2.4 mg, 0.002 mmol), and NaOPh (12.0 mg, 0.10 mmol). To this mixture was added toluene (2 mL), and it was then stirred for 30-60 min at rt. PMHS (0.240 mL, 2 mmol) was then added, and the mixture allowed to stir for 30 min.

2.1 Asymmetric Reduction of Acetophenone

To a 10 mL round bottom flask, equipped with stir bar, oven-dried and purged with argon, was added Cu/C (67.2 mg, 0.05 mmol), (R)-(−)-DTBM-SEGPHOS (2.4 mg, 0.002 mmol), and NaOPh (12.0 mg, 0.1 mmol). To this mixture was added toluene (2 mL), and was then stirred for 30-60 min at rt. PMHS (0.240 mL, 2 mmol) was added, and allowed to stir for 30 min. After addition of PMHS, the reaction flask was placed in a cold bath at −50° C. After 30 min of equilibration, t-BuOH (5M in toluene, .75 mL, 0.25 mmol) was cannulated into the mixture, followed by acetophenone (0.12 mL, 1 mmol). The reaction was allowed to proceed for 8 h to reach completion. The reaction was quenched in NaOH (3M, 10 mL), and was then allowed to stir for 2 h. The catalyst was filtered with a Buchner funnel, and the product was extracted with ether. The aqueous layer was separated and the organic layer dried over anhydrous sodium sulfate, and then evaporated in vacuo. The product was isolated by flash silica gel chromatography (3:1, hexanes:ether), and the ee (91.7 %)was determined by GC analysis on a GTA chiral column.

### Example 2.2

### Asymmetric Reduction of Isophorone

To a 10 mL round bottom flask, equipped with stir bar, oven-dried and purged with argon, was added Cu/C (67.2 mg, 0.05 mmol), (R)-(−)-DTBM-SEGPHOS (11.8 mg, 0.01 mmol), and NaOPh (12.0 mg, 0.1 mmol). To this mixture was added toluene (2 mL), and was then stirred for 30-60 mins at rt. PMHS (0.240 mL, 2 mmol) was added, and allowed to stir for 30 min. Isophorone (0.15 mL, 1.0 mmol) was added to the reaction mixture. The reaction took 45 min to reach completion. The reaction was quenched in NaOH (3M, 10 mL), and was then allowed to stir for 2 h. The catalyst was filtered with a Buchner funnel, and the product was extracted with ether. The aqueous layer was separated and the organic layer dried over anhydrous sodium sulfate, and then evaporated in vacuo. The product was isolated by flash silica gel chromatography (3:1, hexanes:ether), and the ee (98.9%) was determined by GC analysis on a BDM chiral column.

### Example 3

### Representative Procedure for Cu/C-Catalyzed Amination Reactions

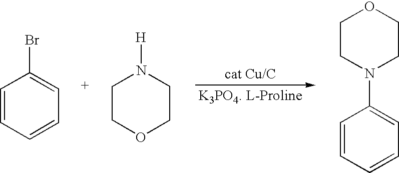

To a flame dried, argon purged 10 mL round bottom flask (RBF) equipped with stirbar, was added under inert atmosphere 90 mg (2.5 mol %) of Cu/C, 530 mg K₃PO₄ (1.25 equiv), 23 mg L-proline (10 mol %), and 23 mg LiOAc (14 mol %). PhBr (210 uL, 2 mmol) was introduced to the reaction mixture, followed by morpholine (300 uL, 3.4 mmol), and then 4 mL of DMSO, taking care to rinse down the sides of the flask to assure all reagents are covered by liquid. The mixture was then heated to 100° C. with stirring for 18 h. The reaction vessel was then cooled to rt, and quenched with 5 mL of H₂O. The reaction was subjected to an extractive workup with water and ethyl acetate. The extracts were washed with brine, and dryied over anhydrous MgSO₄. After removal of solvent in vacuo, the extent of conversion was assessed on the crude isolated material by gas chromatography and determined to be 84% (the remainder being starting PhBr). Isolation of the product by column chromatography on silica (20% EtOAc/hexanes) yields the pure coupled product. GC/MS and NMR data matches that of previously published results. Chem. Eur. J. 2004, 10, 2983-2990.

### Example 4

### Representative Procedure for Cu/C-Catalyzed Alkylation Reactions

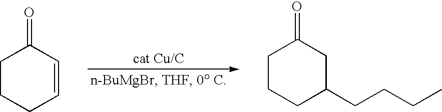

Cu/C (17.5 mg, 0.01 mmol Cu) is placed in a flame dried, argon purged 5 mL long-necked round-bottom flask equipped with stir bar. THF (2 mL) is added via syringe, and the flask is chilled to 0° C. in an ice bath. BuMgCl (0.5 mL, 2 M in THF) is added, and the mixture is allowed to stir for 30 min. In a flame dried, argon purged 5 mL pear shaped flask, cyclohexenone (50 μL, 1 mmol) is dissolved in THF (1 mL) and added to the reaction mixture via cannula. The reaction is allowed to proceed for 20 min, at which point it is complete. An aliquot is removed from the mixture for GC analysis. The GC ratio of 1,4/1,2/double addition is 99.4:0.4:0.2. The reaction is quenched with methanol (1 mL, 25 mmol), and the catalyst is filtered off. The resulting solution is rinsed with water, and then pushed through an anhydrous magnesium sulfate plug. The solution is concentrated by rotary evaporation and the crude material purified by column chromatography (Et₂O:hexanes 1:2, R_{f}=0.36). The material isolated matched previously reported spectral data.

### Example 5

### Representative Procedure for Cu/C-Catalyzed Biaryl Ether Formation

To a flame dried, argon purged microwave vial equipped with stirbar, Cu/C (145 mg, 10 mol %), Cs₂CO₃ (625 mg, 2 mmol), NaOAc (41 mg, 0.5 mmol), 4-methoxyphenol (200 mg, 1.6 mmol) and 1-bromonaphthalene (165 mg, 0.8 mmol) were added under inert atmosphere. N-methylpyrrolidone (NMP, 2.5 mL) was added, taking care to rinse down the side of the flask to ensure that all reagents are covered by solvent. Microwave irradiation with heating up to 200° C. was applied for 2 h. The reaction vessel was then allowed to cool to rt, and quenched with 5 mL of H₂O. The mixture was then transferred to a separatory funnel, and further diluted with water and ethyl acetate. The organic layer was collected, and the aqueous layer was further extracted with two more portions of ethyl acetate. The organic layers were combined, washed once with brine, dried over anhydrous MgSO₄, and then reduced in vacuo. The identification of the product as 1-(4-methoxyphenoxy)naphthalene, was confirmed by GC/MS, the data matching that of previously published results.

While this invention has been disclosed with reference to specific embodiments, it is apparent that other embodiments and variations of this invention may be devised by others skilled in the art without departing from the true spirit and scope of the invention.

All patents, patent applications, and other publications cited in this application are incorporated by reference.

What is claimed is:

1. A composition comprising a copper complex absorbed onto a substrate, said copper complex having the formula:
Lₘ—Cu(Z)
wherein
L is a ligand;
m is an integer from 1, 2 and 3, such that when m is greater than 1 each L is independently selected; and
Z represents an oxidation state of said copper and is an integer selected from 0, 1 and 2; and
said substrate is carbon.

2. The composition according to claim 1 wherein L is a phosphine ligand.

3. The composition according to claim 1 wherein L is a chiral, non-racemic ligand.

4. A method of performing an addition across an unsaturated system in a 1,2 or 1,4 manner, said method comprising contacting an unsaturated substrate with a compound according claim 1 under conditions appropriate to effect said addition.

5. The method according to claim 4 wherein said addition is an asymmetric addition.

6. The method according to claim 5 wherein said addition is an asymmetric reduction.

7. The method according to claim 6 wherein said asymmetric reduction is a hydrosilylation, said method further comprising:
(b) contacting said substrate with a silane compound.

8. A composition comprising a copper complex absorbed onto a substrate, said copper complex having the formula:
Lₘ—Cu(I)—H
wherein
L is a ligand;
m is an integer selected from 1, 2 and 3, such that when m is greater than 1 each L is independently selected; and
said substrate is carbon.

9. The composition according to claim 8 wherein L is a phosphine ligand.

10. The composition according to claim 8 wherein L is a chiral, non-racemic ligand.

11. The composition according to claim 8, in a mixture with a salt of a member selected from an organic acid, an inorganic acid, an organic alcohol and combinations thereof.

12. A method of performing the reaction: 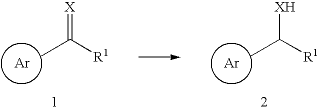
wherein
2 produced in said reaction is an optically active compound that is a member selected from: 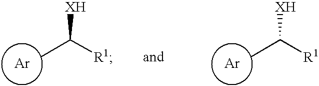
wherein
Ar is a member selected from substituted or unsubstituted aryl and substituted or unsubstituted heteroaryl moieties;
R¹is a member selected from substituted or unsubstituted alkyl, substituted or unsubstituted acyl, substituted or unsubstituted heteroalkyl, substituted or unsubstituted aryl, substituted or unsubstituted heteroaryl and substituted or unsubstituted heterocycloalkyl moieties; and
X is a member selected from O and NR²
wherein
R² is a member selected from H, acyl, substituted or unsubstituted alkyl, substituted or unsubstituted heteroalkyl, substituted or unsubstituted aryl, substituted or unsubstituted heteroaryl and substituted or unsubstituted heterocycloalkyl,
said method comprising:
(a) contacting 1 with the copper species according to claim 8.

13. The method according to claim 12, further comprising:
(b) prior to step (a) contacting said copper complex with a salt of a member selected from an organic acid, an inorganic acid, an organic alcohol, and combinations thereof.

14. The method according to claim 12 wherein Ar is substituted or unsubstituted phenyl.

15. A method of performing the reaction: 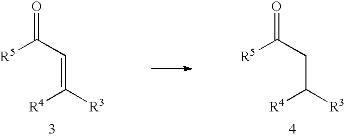
wherein
4 produced in said reaction is an enantiomer that is a member selected from: 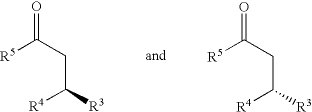
wherein
R³, R⁴, and R⁵ are members independently selected from H, substituted or unsubstituted alkyl, substituted or unsubstituted aryl, substituted or unsubstituted heteroaryl and substituted or unsubstituted heterocycloalkyl, and
R⁴ and R⁵, together with the carbon atoms to which they are bound are optionally joined to form a substituted or unsubstituted 5-15-member cycloalkyl or substituted or unsubstituted 5-15-member heterocycloalkyl moiety,
said method comprising:
(a) contacting 3 with the copper complex according to claim 8.

16. The method according to claim 15, further comprising:
(b) prior to step (a) contacting said copper complex with a salt of a member selected from an organic acid, an inorganic acid, an organic alcohol, and combinations thereof.

17. A method of producing a composition comprising a copper complex absorbed onto a substrate, said copper complex having the formula:
Lₘ—Cu(Z)
wherein
L is a ligand;
m is an integer from 0, 1, 2 and 3, such that when m is greater than 1 each L is independently selected; and
Z represents an oxidation state of the copper and is an integer selected from 0, 1 and 2; and
said substrate is carbon
said method comprising:
(a) forming a mixture of a copper salt and activated carbon in aqueous medium;
(b) sonicating said mixture; and
(c) removing said aqueous medium, forming a copper salt absorbed onto carbon; and
(d) contacting the product from step (c) with a non-racemic ligand, thereby forming said copper complex absorbed onto carbon.

18. A method of producing a composition comprising a copper complex absorbed onto a substrate, said copper complex having the formula:
Lₘ—Cu(I)—H
wherein
L is a ligand;
m is an integer from 1 to 3, such that when m is greater than 1 each L is independently selected; and
said substrate is carbon
said method comprising:
(a) forming a mixture of a copper salt and activated carbon in aqueous medium;
(b) sonicating said mixture; and
(c) removing said aqueous medium, forming a copper salt absorbed onto carbon;
(d) contacting the product from step (c) with a non-racemic ligand, thereby forming complexing said copper absorbed onto carbon; and
(e) contacting the product of step (d) with a silane, thereby forming said copper complex.
